(19) United States
(12) Patent Application Publication
(10) Pub. No.: US 2005/0033596 A1
(43) Pub. Date: Feb. 10, 2005

(54) Web-accessible, single-tier host-server-side computer programming application and the backend supporting business processes that represent a turnkey solution to "enable the turnkey activation of affordable, private, secure, scalable, sophisticated and extensible hierarchical communication networks for a plurality of American communities comprised of a plurality of members who may use any internet service provider (ISP) and who may use any relevant web browsing client in any relevant PC operating system to access the capability."

(76) Inventor: John F. Tummolo, Boca Raton, FL (US)

Correspondence Address: ABB ABBIEL, LLC. (JOHN TUMMOLO), Box 970543, BOCA RATON, FL, 33497, US

(21) Appl. No.: 10/877,702

(22) Filed: Jun. 26, 2004

Related U.S. Application Data
(60) Provisional application No. 60/482,805, filed on Jun. 26, 2003.

(51) Int. Cl. G06F 17/60

(52) U.S. Cl. 705/1

(57) ABSTRACT

A web-accessible host-server-side computer programming application and the supporting business processes that represent a turnkey solution to “enable the turnkey activation of affordable, private, secure, scalable, extensible communication networks for a plurality of American communities comprised of a plurality of members who may use any internet service provider (ISP) and who may use any relevant web browsing client in any relevant PC operating system to access the capability.”

This non-provisional utility patent application claims the benefit of priority of the previous application No. 60/482,805 filed on Jun. 26, 2003.

A web-accessible, single-tier host-server-side computer programming application and the backend supporting business processes that represent a turnkey solution to “enable the turnkey activation of affordable, private, secure, scalable, sophisticated and extensible hierarchical communication networks for a plurality of American communities comprised of a plurality of members who may use any internet service provider (ISP) and who may use any relevant web browsing client in any relevant PC operating system to access the capability.”

### CROSS REFERENCE TO RELATED APPLICATIONS

Provisional Patent 60/482,805 Jun. 26, 2003

### STATEMENT REGARDING FED SPONSORED R&D

Non-applicable. This patent is not associated with any federally-sponsored research and development effort.

### REFERENCE TO SEQUENCE LISTING, A TABLE, OR A COMPUTER PROGRAM LISTING APPENDIX

This patent does not seek to protect the line-by-line literal programming source code and instruction logic paths used to support the data-design, functional capabilities and user-interfaces this patent seeks to protect.

### BACKGROUND OF INVENTION

The present inventor conducted a study from the various perspectives of layperson business community leaders, residential community leaders, condominium leaders, cooperative apartment leaders, rental apartment complex leaders, school leaders, religious leaders and/or layperson members from any of these communities who desired to turnkey activate and thus make-available, a high-quality, feature-rich, extensible, scalable, private, https/ssl-secure, community communications and informational network application via the internet. The effort to activate such capabilities should demand less, or equal, the time and effort expressed by the same individual purchase the services of a subcontracting vendor providing landscaping, plumbing or other services. In other words, was there a web-accessible application that simplified the deployment of a complex community communications network capability simply through a typical brief inquiry and subsequent payment transaction?

The results of the study concluded there were no such web-accessible applications providing such advanced turnkey features and capabilities.

The inventor has created a convenient, secure and private community-oriented web application that potentially enables every American community member to continue fostering such community spirits filled with free expression in their day-to-day lives. The intent of this web application is to enable community members to improve day-to-day communications for such purposes as welcoming newcomers, forming social groups, strengthen neighborhood watches, enabling local community members to share relevant news and information, and to seek and build relevant interesting social relationships by interacting within a dynamic list of topics. This invention is intended to strengthen the fabric of American communities by creating a convenient means for members to “plug into” their relevant local community network.

With the same spirit of patents previously granted to inventors of web-accessible computer application programs and supporting business models such as “online auctions” (i.e., “eBay”), the present inventor seeks to protect the invention of a web-accessible, single-tier host-server-side computer programming application and the backend supporting business processes that represent a turnkey solution to “enable the turnkey activation of affordable, private, secure, scalable, sophisticated and extensible hierarchical communication networks for a plurality of American communities comprised of a plurality of members who may use any internet service provider (ISP) and who may use any relevant web browsing client in any relevant PC operating system to access the capability.”

### SUMMARY OF INVENTION

The present invention enables a turnkey solution defined as “a web-accessible, single-tier host-server-side computer programming application and the backend supporting business processes that represent a turnkey solution to ‘enable the turnkey activation of affordable, private, secure, scalable, sophisticated and extensible hierarchical communication networks for a plurality of American communities comprised of a plurality of members who may use any internet service provider (ISP) and who may use any relevant web browsing client in any relevant PC operating system to access the capability.’”

The turnkey activation enables the mass-production of affordable, private, secure, scalable, extensible communication networks for American communities by enrolled community members who may use any internet service provider (ISP) and who may use any relevant web browsing client from an array of relevant PC operating systems.

The present invention is comprised of a single-tier web server, loaded with a set of proprietary C-language application programs that provide private and secure community communications networked features and functions along with server-side member session-support functions such as partitioned database I/O, dynamic web page generation and https/ssl web serving to a plurality of entitled members using client PCs with relevant web browsers accessing the internet via any internet service provider (ISP) internet connection. The present invention is also comprised of a set of business processes that enable scalability to support tens-of-millions of members and membership support services. This invention also includes the creation of a governing “content and functions” hierarchical framework architecture for providing a rich hierarchical content and functions user-interface at every level of the dynamic topical drill down menus.

### BRIEF DESCRIPTION OF DRAWINGS

The present invention will be understood and appreciated more fully from the following detailed descriptions taken in conjunction with the drawings in which:

FIG. 1 is a print out of a sample web-accessible turnkey application access point branded as www.mycommunitylink.com. The key functions such as enrollment, demo trial and login can be easily cut and pasted into any branding environment, along with modified parameters on the enrollment pages to re-brand the application.

FIG. 2 is a printout of the web accessible turnkey membership enrollment form where a new community name entered would trigger the turnkey creation of a new, private and secure community communications network application.

FIG. 2a is a continuation of the web-accessible turnkey membership enrollment form exhibiting prompts to create member passwords and secret questions in the event of lost ids or passwords. Ids are automatically generated as a result of approved credit card transactions to ensure member id assignments are unique country-wide.

FIG. 3 is a printout of a private and secure community network web page for a demonstration community named “demo community.” Here, the current page location is on “main topics” where members can add calendar entries, featured content, interactions, surveys, photos and sub-topics making these interactions relevant to the gross-level hierarchy main parent-level “>>main topics”. Each private community is divided into two messaging zones. This page is a Zone I area. Zone I is for applying messages, surveys, content and topics in the topical hierarchy. Zone I information is seen by every member accessing the private community.

FIG. 4 is a printout of the private “one-to-some number of members” encrypted messaging page. This page is accessible from any service page by clicking Zone II: private messaging.

FIG. 5 is a printout similar to FIG. 3 except in a different hierarchical content location. It is still a private and secure community network web page for the demonstration community named “demo community.” Here, the current page location is on “acting schools” where members can add calendar entries, featured content, interactions, surveys, photos and sub-topics making these interactions relevant to the detailed-level hierarchical child content segment level “acting schools.” Notice the “you are here” navigational path is “>>main topics >>arts & entertainment >>acting >>acting schools”. Each private community is divided into two messaging zones. This page is a Zone I area. Zone I is for applying messages, surveys, content and topics in the topical hierarchy. Zone I information is seen by every member accessing the private community.

FIG. 6 is a printout of the “add a topic” dialogue box. Community members are able to create topics and delete them until other members interact within these topics. Once created, the topic becomes community property, but can be deleted by the original author as long as no other member has contributed to the topic.

FIG. 7 is a printout of the “add an interaction” dialogue box. Community members are able to create interactions within the current hierarchical topic. At that point, the interaction becomes community property and can not be deleted by community members. However, offensive or inappropriate content may be deleted at the discretion of the application service provider content management personnel per the terms and conditions governing the service.

FIG. 8 is a printout of the service comparison features matrix

FIG. 8a is a printout of the continuation of the service comparison features matrix.

FIGS. 9 and 9a is a schematic illustration (diagram) detailing the underlying data and function hierarchical data design that supports the creation and mass-production of distinct, partitioned communities on one or more single-tier host servers.

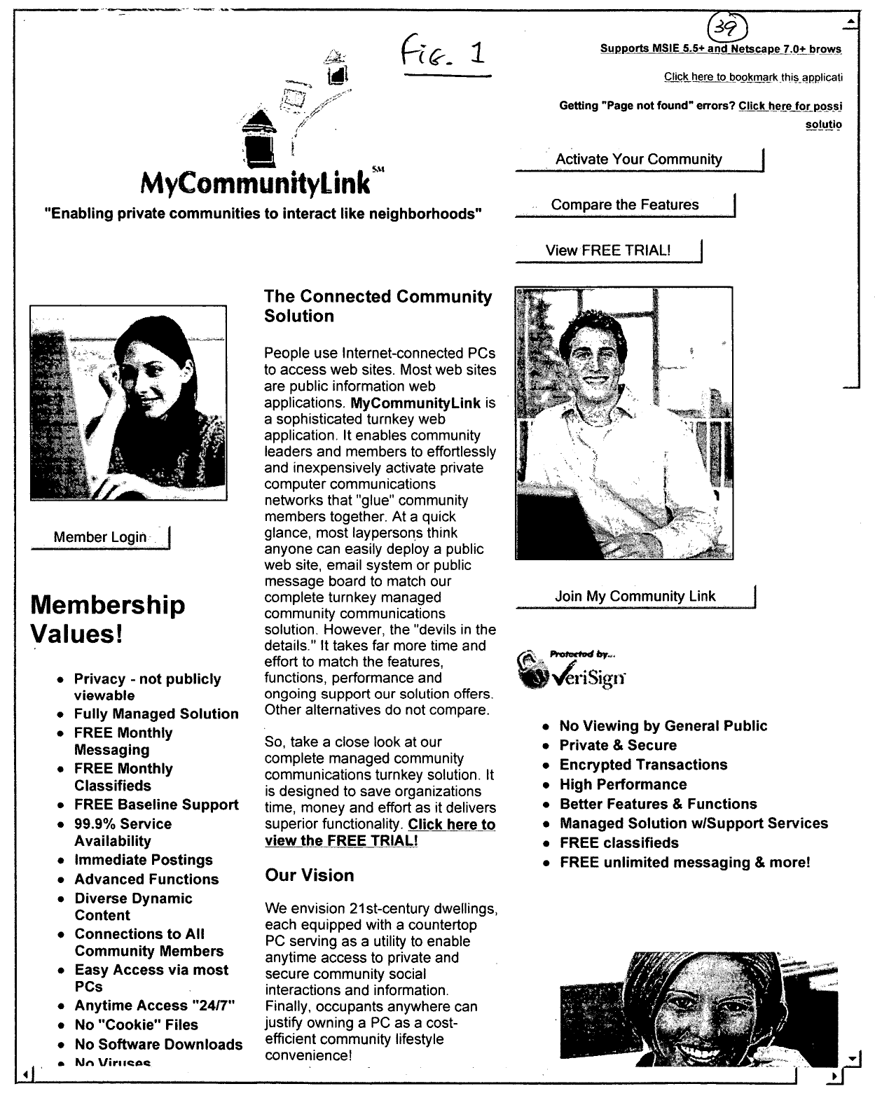

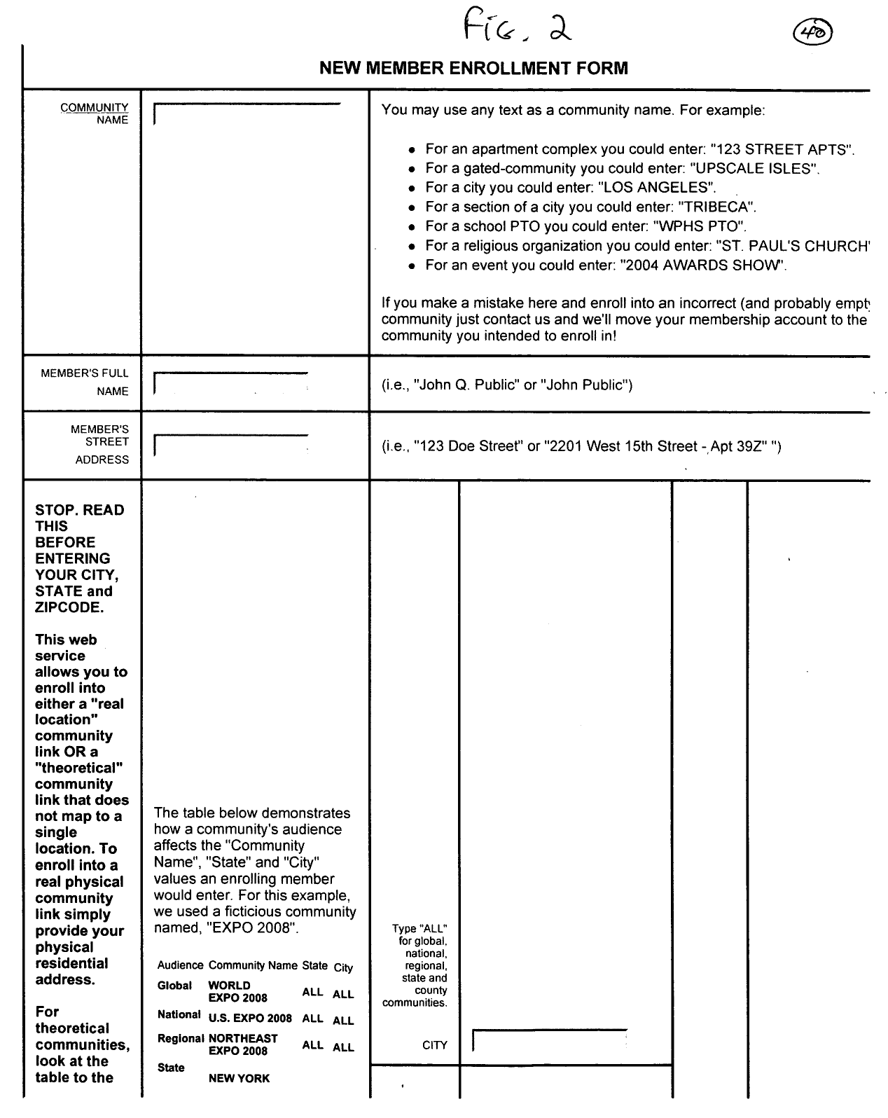

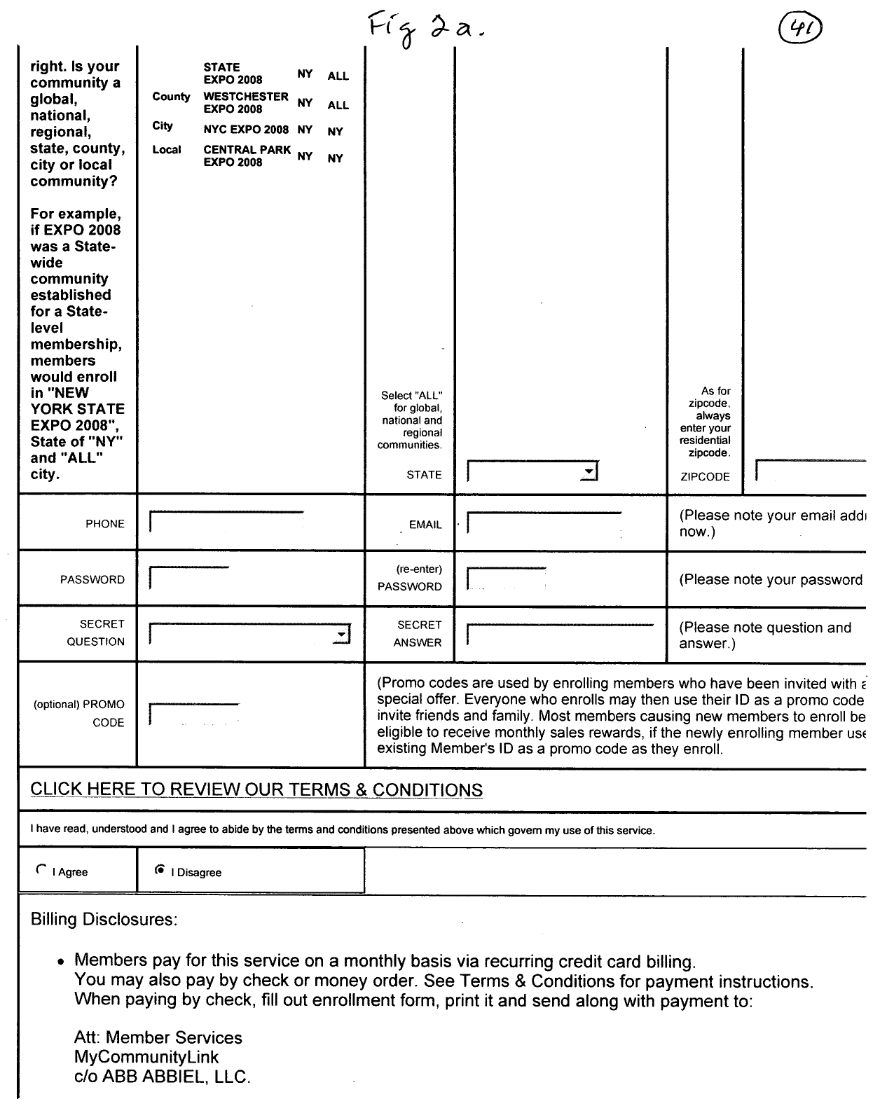

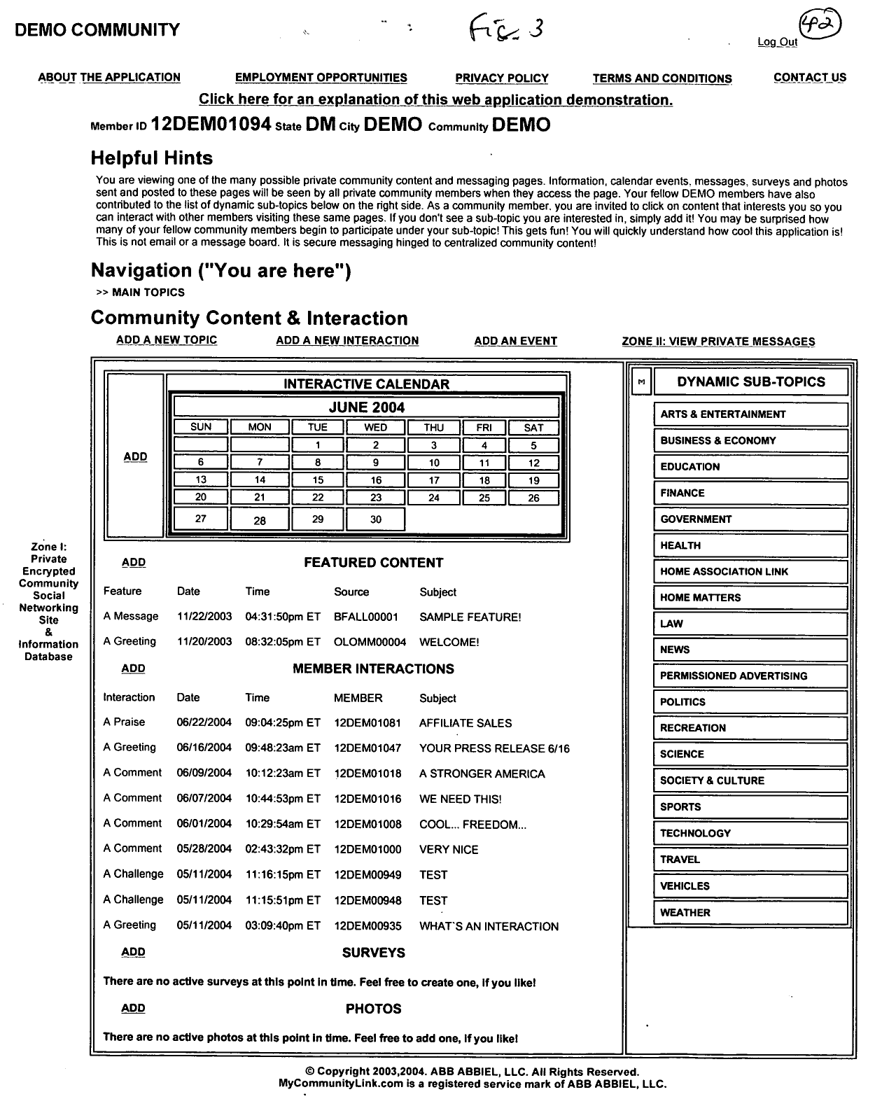

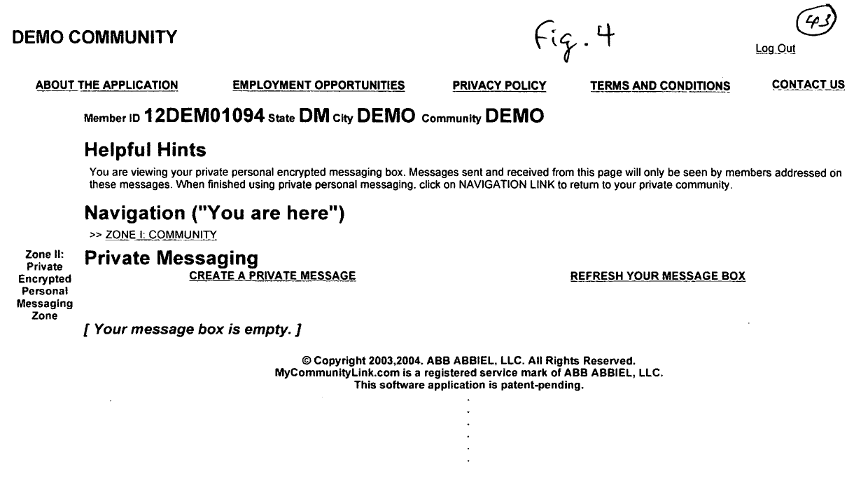

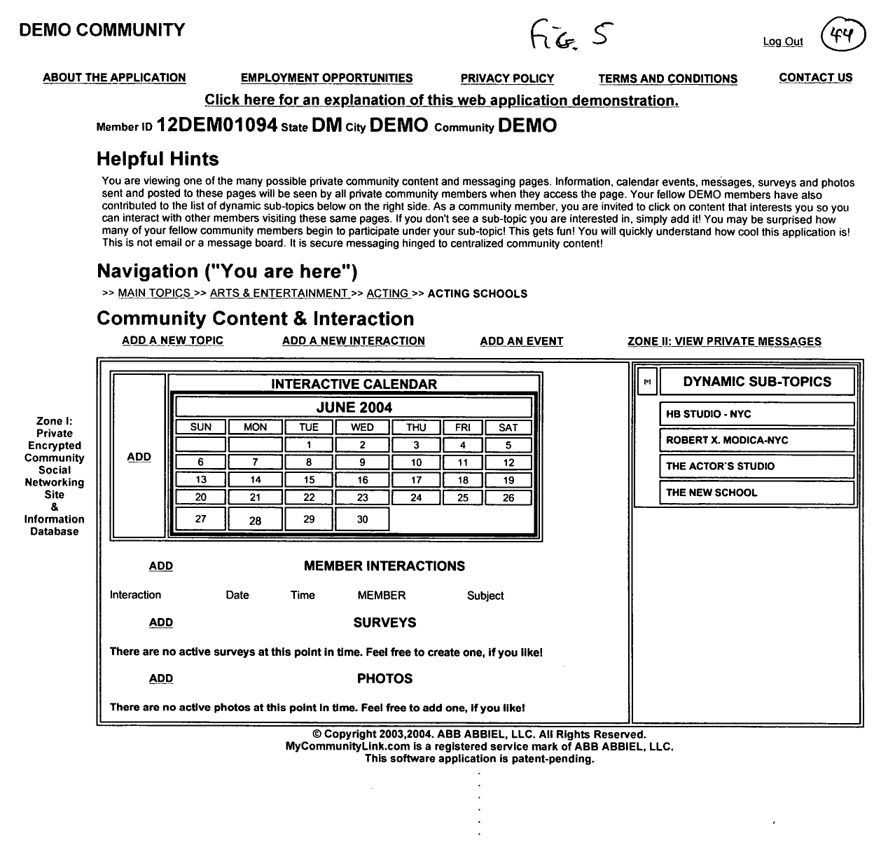

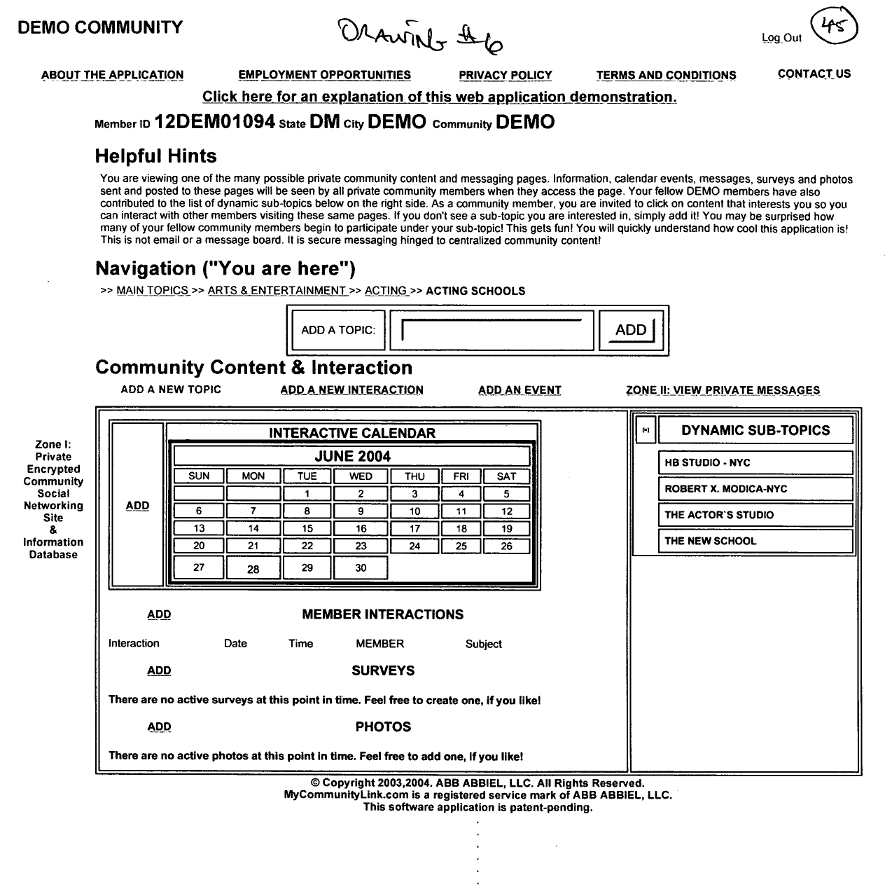

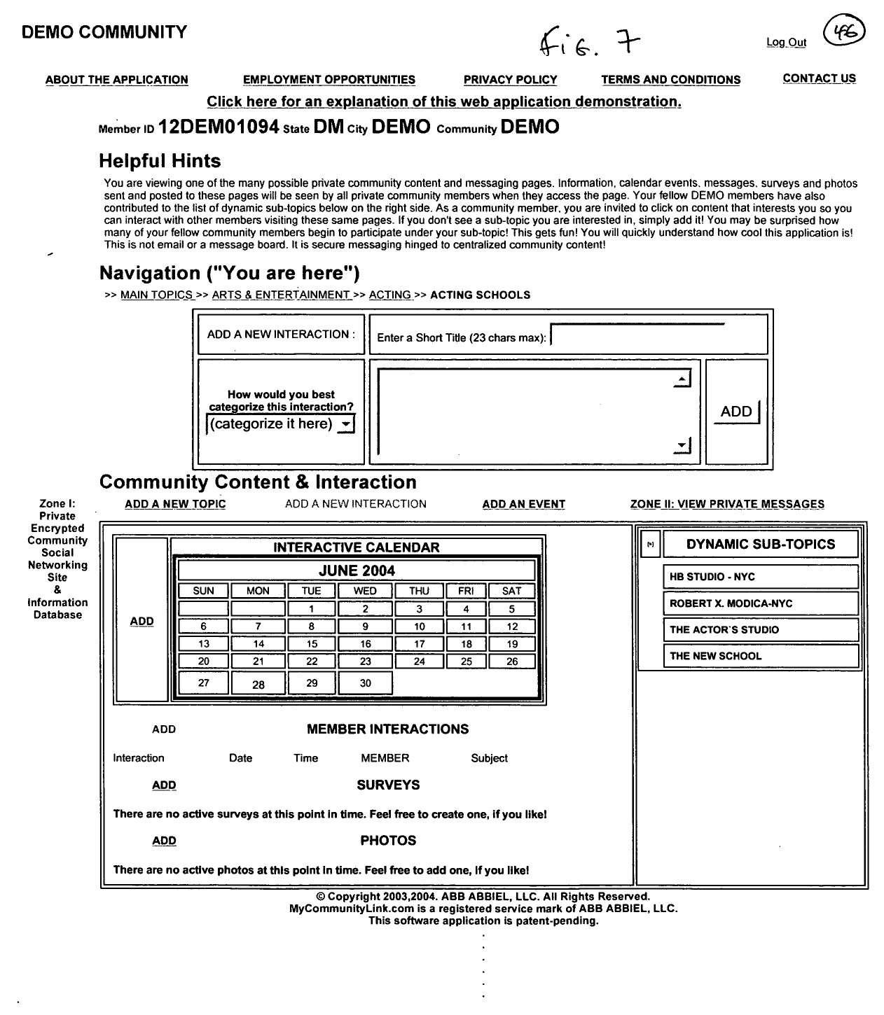

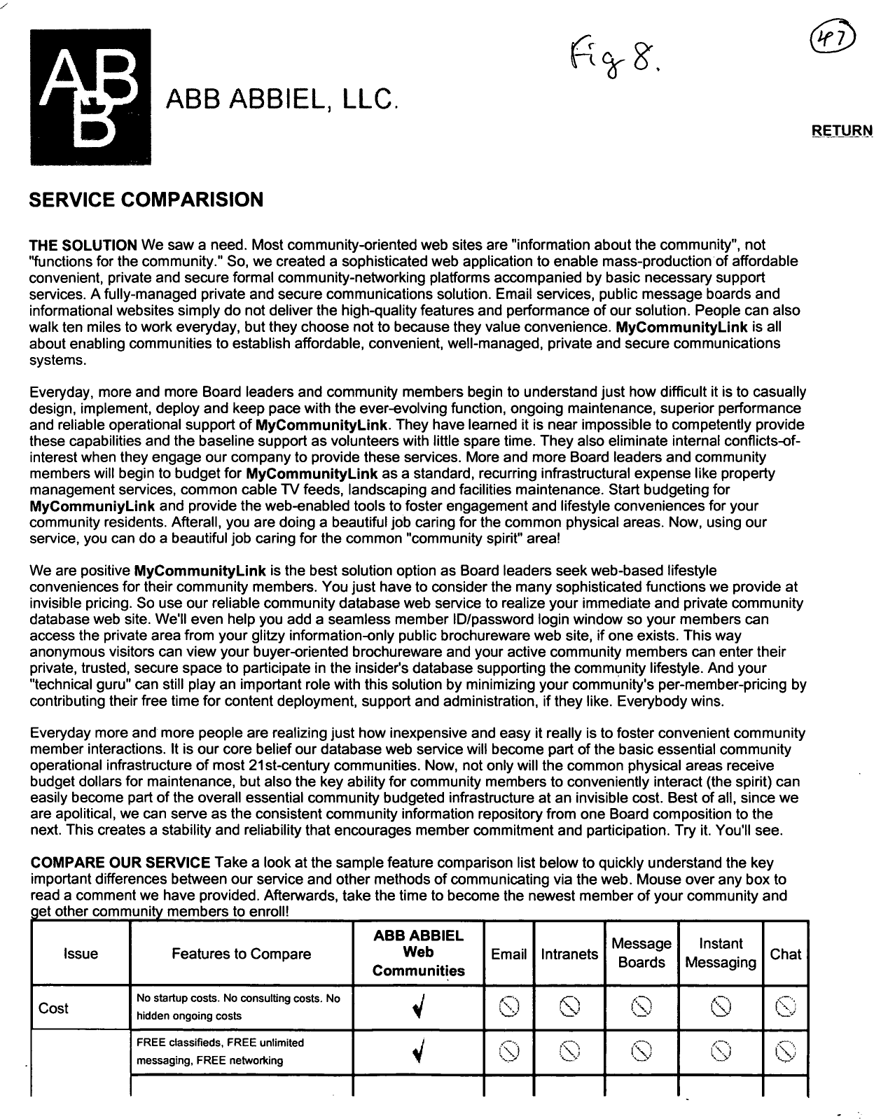

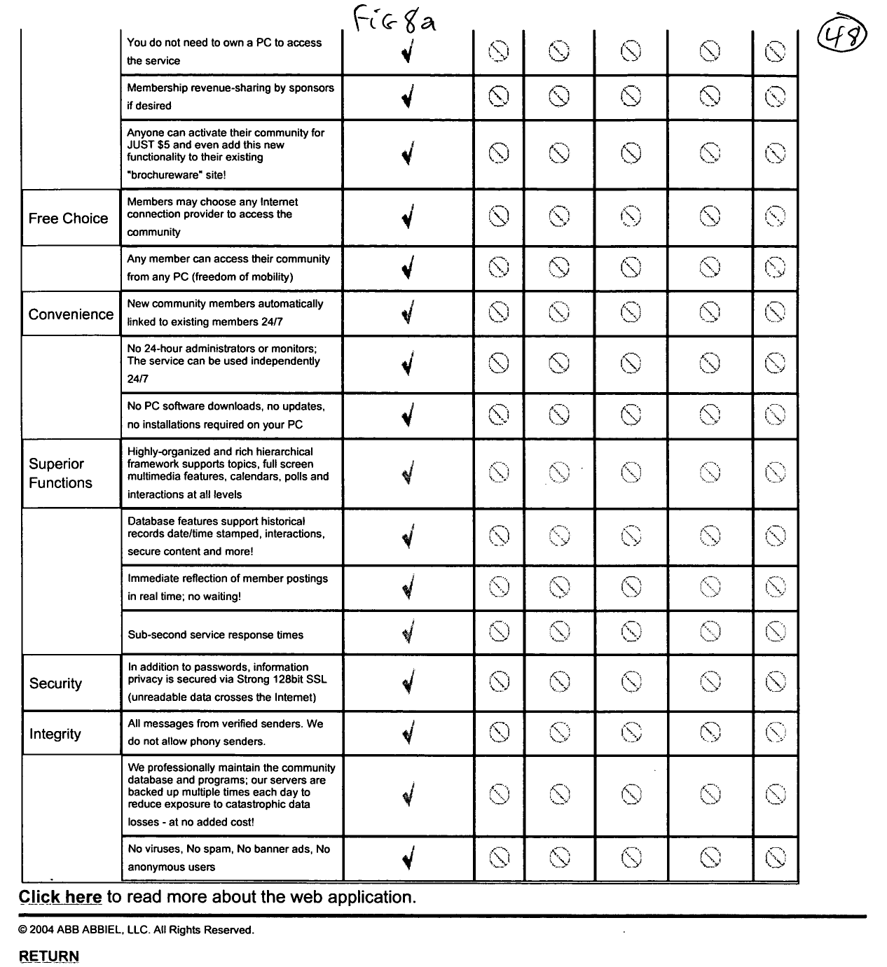

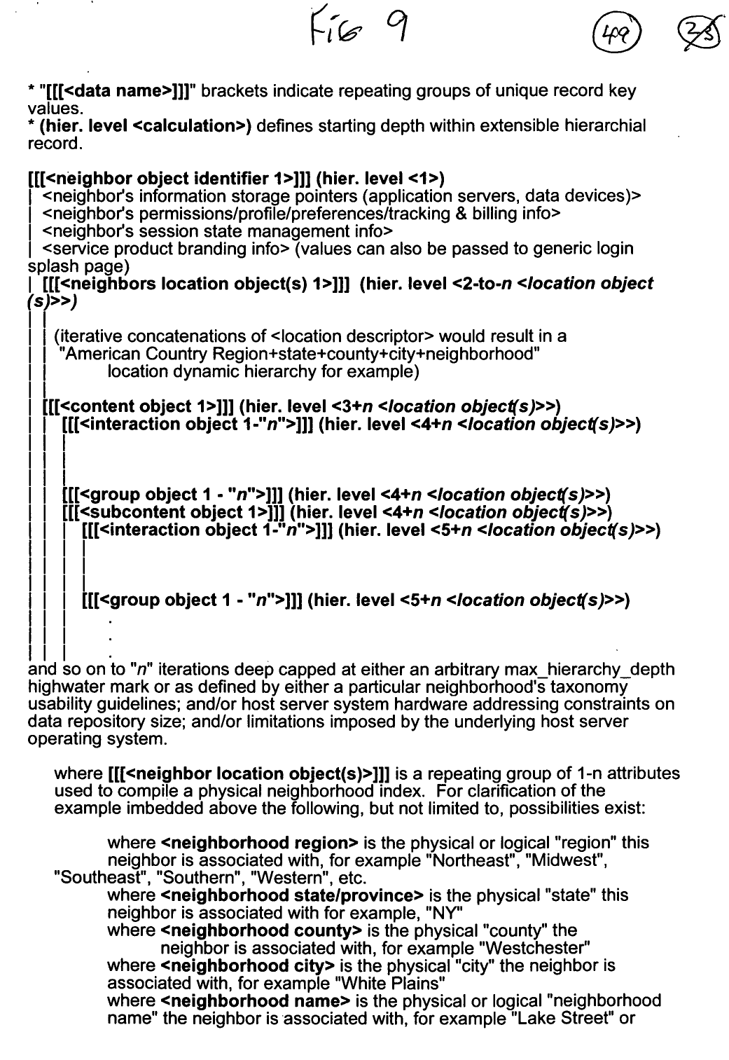

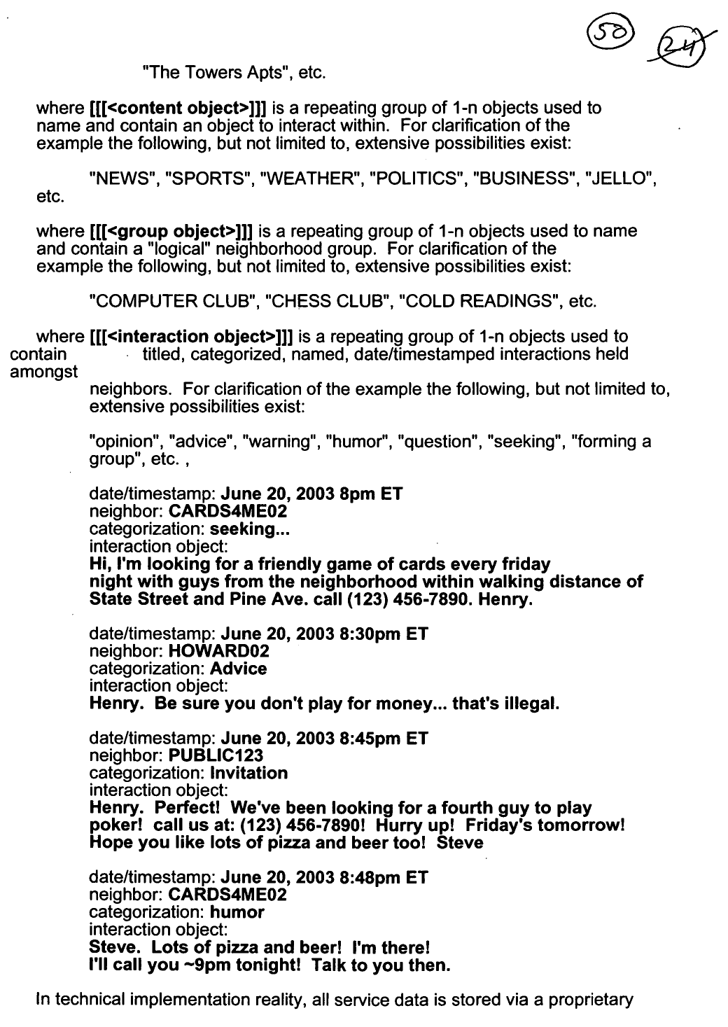

### DETAILED DESCRIPTION

A Comprehensive Solution

The present invention is a comprehensive turnkey solution that enables the turnkey activation and usage of a plurality of sophisticated, private, secure, scalable, extensible, community-oriented communications networks that offer private member-modifiable, hierarchical topical templates of content and functions made “relevant” thru interactions by private community members when they apply content, messages, surveys and other types of communicative interactions. The solution is comprised of simple host-server-side application C-language program modules, a plurality of single-tier ssl servers, http port 80 brochure ware servers, a set of supporting business processes and a plurality of community member client PCs accessing the internet via any internet service provider (ISP) using most any relevant web browsing client.

The turnkey server-side application program solution facilitates the turnkey activation of complex community-oriented communications networks that are private, secure, and dynamic topically-oriented templates waiting to be “made community relevant or community personalized” communication systems via interactions placed by private community members when they apply content, messages, surveys, and other types of communicative interactions.

Physical Technical Hardware/Software Architecture Behind Solution

Overview

The technical architecture enables this turnkey solution to potentially accommodate tens of millions of community members. As with most web-based solutions, the constraints are bandwidth and server capacity. Due to the inherent nature of private communities, each community can be partitioned to exist within its own bandwidth and server environment, effectively minimizing scalability concerns as the solution propagates into communities across America. However, the solution is able to adapt to a single community of significant size (perhaps millions) as a result of carefully-structured, well-planned, well-managed host server operational scaling procedures implemented over a period of time.

A. Client Side Logic—JavaScript and html

The present solution seeks to accommodate the highest-possible number of client PC machines, client PC operating systems and client PC web browsers. Therefore, the use of physical PC session-state files, including “cookie files” and client-side specialized software installations (a.k.a., “thin clients”) has been consciously avoided. This decision supports the present inventor's objective of creating flexible PC access points (i.e., “mobility”) by relying upon the particular client PC's relevant web browser to affectively serve as the client-side logic-processing and presentational environment. This deems the client PC's web browser as the official application programming interface (API) for the server-side logic to communicate with, thereby removing specific awareness of any given community member's client PC hardware and software configuration. This creates a truly independent, non-specific-member-restricted mobility allowing members to affectively access their community from any PC within tolerable and relevant web browser specifications.

All pages dynamically-created by host-server-side CGI programs to represent a given community member's session-state are formatted using html tags.

JavaScript is required to enable the client-side PC to perform rudimentary data-entry validations and pre/post navigational logic in an effort to cut down on the https://CGI traffic sent to the host-server. In other words, the server is there to perform database recording and maintain a member's client PC presentation web page session state, not to serve as a “data-entry validator” when this work can be distributed amongst the user client PC base. This architecture does place a small requirement on a member's PC access point—their web browser security settings must be set to “allow JavaScript”, at least for our “trusted site.” Members attempting to access our solution with JavaScript disabled will be met with a request to “enable JavaScript”. All clickable navigation links on member client PC screens will generate blank web pages until JavaScript is enabled in their web browser. In addition, users must enable browser popup windows for the service in order to access core service windowed functions.

A conscious decision was made to support relevant web browsers. Older web browsers lacking cascading style sheets (css) support (<MSIEv5.50 and <NSv6.0), are not supported due to the very essence older browsers contain significant security, functional and performance flaws that should be addressed by the client PC administrator anyway. CSS affectively enables a significant byte count compression of html page creation parameters, in many cases reducing five packets worth of bytes or more per page request. This is purely an altruistic decision aimed at lessening our contribution to the HTML ASCII-text congestion of our Internet, since the programmatic creation of redundant html formatting tags is as simple for us as the creation of tokenized CSS format style IDs.

B. Server-Side C-Language CGI Programs

The present invention is essentially comprised of a plurality of single-tier internet-accessible https://host-server-side CGI C-language programs that receive a plurality of community member client PC incoming common gateway interface (CGI) TCP/IP https://requests, process these requests based on function-related parameters, and reply with dynamically-created https://html web pages responses appropriate to the particular member's current session state and presentational web page html needs. These CGI programs are designed to run in a simple, single-tier host server common gateway interface (CGI) environment and have been designed to minimize program module memory demands and utilization. Due to this design, hundreds of modules can be loaded into memory to support peak concurrent transaction periods, each completing complex tasks in milliseconds. For most communities, this peak concurrent processing potential represents more than adequate load capacity.

C. Single-Tier Host Server Architecture

Therefore, a single-tier host server is intended to support one or more communities to reduce the relative capital expenditure for a single host server into an economy of scale profit margin. These economies-of-scale, partnered with the deliberate designed-in simplicity of the CGI application programs, enables the turnkey solution to be invisibly-priced for the consumer. Each server is tasked to support various time zones across the U.S., effectively distributed peak-hour usage demands for a given server to manage-down peak utilization metrics. As bandwidth utilization and/or server CPU processing utilization reach a pre-determined proprietary-in-house maximum allowable percentage of maximum utilization, a scalable host server plan dictates one or more communities on the “stressed” host server may be re-deployed to lower-utilized host server machines as transaction activity report suggest. In the event one community exceeds a single-tier server's capacity to reasonably process incoming and outgoing client PC transactions, or incoming bandwidth to that server is near the proprietary- in-house maximum allowable bandwidth utilization demands (highly-unlikely), a small server-side application program residing on each server will manage incremental real-time updates across the allocated number of single-tier servers and members will be load-balanced across the “mirrored” servers seamlessly. It may be likely when such mirroring occurs, that a single community member may interact with two or more servers seamlessly during their session without perceiving any data-concurrency anomalies. In the event mirroring occurs, the plurality of servers will effectively be leveraged as inherent and intrinsic disaster-recovery operations should any one of the mirrored web servers fail. Load-balancing of incoming member client PC requests will be managed by a hardware load-balancer able to redirect to responsive assigned servers.

D. Server-Side Databases

All server-side database management and functions have been coded using proprietary-in-house low-level file I/O C-language routines. There is no requirement to utilize third-party database software or database query interface APIS/languages. This key design decision was undertaken to improve operational scalability metrics, lower equipment utilization and related capital expenditure metrics, eliminate licensing fees, eliminate third-party technical support fees, eliminate dependencies on third-party bug fixes and problem determination priorities, improve maintenance and monitoring procedures, to eliminate third-party security breach “backdoors”, to optimize server runtime performance response times, to design inherent parallel-redundancy within the database schema itself reducing the likelihood of catastrophic all-database loses, etc.

The net bottom line: we wanted to own the solution so we could affectively manage it and extend the cost savings to our customers through invisible pricing.

E. SSL Web Servers

All server side ssl web servers are proprietary in-house deployments. There is no requirement to utilize commercial third-party web servers. We own the dedicated servers. We do not share web servers used by unrelated third-parties.

This key design decision was undertaken to improve operational scalability metrics, lower equipment utilization and related capital expenditure metrics, eliminate licensing fees, eliminate third-party technical support fees, eliminate dependencies on third-party bug fixes and problem determination priorities, improve maintenance and monitoring procedures, to eliminate third-party security breach “backdoors”, and to optimize server runtime performance response times.

The net bottom line: we wanted to own the solution so we could affectively manage it and extend the cost savings to our customers through invisible pricing.

F. HTTP Web Servers

It's cheaper to allow a commonly-available web page hosting/serving company to deliver our non-functional insecure promotional front-end content. This enables us to steer casual port 80 bandwidth utilization away from our secure server infrastructure, maximizing our community member session support capacity. Therefore, all promotional brand-oriented “brochure ware” content may be hosted and served using standard TCP/IP port 80 http public and insecure unencrypted commercially-available hosting companies. The brochure ware contains links to our backend functional ssl web servers. This decision represents a cost-efficient means for deploying multiple marketing brand front ends that map into a lean backend SSL server farm.

Functional Logic of Present Invention

A. Turnkey Activation of Community Communications Network

The present invention is designed to create a partitioned, separate logical community communications network database upon recognition of a new member enrollment into a non-existent community name. This is deemed a “first-member” enrollment. Since all enrollments are created by supplying a relatively limited amount of enrollment information, followed up by a credit transaction, a “first-member” enrollment path affectively creates a unique solution for the member in a matter of minutes. This is defined as a “turnkey” solution that clearly eliminates all design, planning, implementation and operational management time and costs. The newly enrolled “turnkey” first-member now has a fully-operational, sophisticated, private and secure community network application deployed and ready for subsequent community member enrollments.

B. Marketing the Invention Via Flexible Front-End Brochure Ware

The present invention allows for re-branding of the server-side html responses for the purposes of marketing the solution to different prospective audiences. In other words, membership enrollment forms can be configured to pass the enrolling-source marketing “brand” product's name such as www.mycommunitvlink.com or www.myresortslink.com, etc. as part of the enrolling member's personal profile. The solution can also be modified to pass enrolling member's “powered by” brand name such as “powered by Blogfrenzy” or “powered by MyCommunityLink”. Therefore, subsequent access by a community member using a PC client web browser supplying that member id will brand the member's presentation web pages with the relevant “community name” and “service powered by” attributes. This enables a single ssl application host server to easily support different brand deployments and communities.

The present invention therefore allows the technology to be deployed across a wide array of front-end marketing scenarios.

This enables various sales brochure ware sites to be created as “front doors” for membership enrollment.

Three Core Invention Functions

Each brochure ware site can be configured with the following backend functions:
1. Login member id/password access screen and support links. Successfully passing this access challenge will present a permissioned member into their private community derived from a member profile created at the time of enrollment.
2. New membership enrollment, where first-member enrollment turnkey activates a new community by name. Subsequent member enrollments to the same community create incremental new member enrollments to an existing community. Enrollment includes real-time credit card processing. Upon successful credit card authorization, a new member is presented with a system-generated member id to complement their specified password. They are not fully-permissioned to access their community. This solution enables membership enrollment for first and subsequent members to take place within five minutes. This inherently establishes the “turnkey” nature of this solution.
   Manual assisted enrollment business processes enable a phone call supported by a list of member names, addresses, email addresses (optional) and telephone contact number and a check for monthly access for communities greater than 25 members;
   depending upon circumstances, some communities mat opt to pay- by-check on a monthly basis for member service access, while other communities may opt to have each member billed via recurring monthly credit card processing;
3. Trial demonstration link allowing prospects to preview the capabilities which have been scoped to provide limited functionality.

The remaining content of the brochure ware site can be developed independently of the invention for market purposes.

C. Community Communications Functions

A. Enrollment

B. Login

C. Community networking comprised of:

A plurality of dynamic content web pages contributed to by a plurality of private community members, each community network page containing the following potential content and functions:
1. Each community web page is content organized within a framework of dynamic hierarchical topics provided by a community's membership base;
2. The ability to add a plurality of new topics as “children” to a parent topic and to delete topics before other members interact within them;
3. The ability for everyone in the community to add a plurality of new message interactions relevant to the current viewed hierarchical topic as well as to view and respond to; once a message is added it can not be deleted unless deleted by a service administrator;
4. The ability for everyone in the community to create, view, add or delete a plurality of calendar entries relevant to the viewed hierarchical topic. Calendar entries can only be deleted by the member who placed them, or by a content administrator;
5. The ability to create a plurality of featured content, including non-secure external links and secure internal content links to web pages, downloads and multimedia web pages, relevant to the viewed hierarchical topic.
6. The ability to create, view and participate in a plurality of surveys relevant to the viewed hierarchical topic;
7. The ability to add or delete a plurality of photos relevant to the viewed hierarchical topic; photos can only be deleted by the member who placed them, or by a content administrator;
8. The ability to enter the private one-to-some messaging area, comprised of:
   a) The ability to send messages sent to a limited subset of community members;
   b) The ability to receive messages from other inter/intra-community members;
   c) The ability to delete sent/received messages;
   d) The ability to return to the last community topic page;
      D.) Direct-Permissioned Marketing, Classified Ads, Networking Ads, etc.

This present invention is essentially an empty hierarchical topic template that can be leveraged to provide a wide-range of resulting functionalities, including, but not limited to:
1. Classified advertising amongst community members;
2. Networking ads amongst community members;
3. Local vendor ads targeting specific communities;
4. Personals;
5. Help wanted;
6. Etc., etc.
   E.) Logic to Increase Integrity of Present Invention

The present invention includes various logical server-side-managed protocols and software routines as checks to prevent hackers, spam, intrusions and exploits of private community information; comprised of:
1. A method for assigning arbitrary and dynamic last transaction keys in place of passwords to prevent exploitation or “hijacking” of member sessions;
2. A method for determining when an invalid request has been sent to the server;
3. A method for communicating a violation to intruder;
4. A method for clearing a member's session-state status upon intrusion detection;
5. A method for ensuring valid page views by PC clients;
6. A method for preventing one community member to access another community's information by manipulating https://parameters
   More Detail Included—as a Precaution (May be Partially Redundant)
   Notice to Patent Examiner

Oct. 21, 2004—the following section has been kept in-tact as found in the original non-provisional patent submitted June 2004 and is returned as part of the response for corrections requested from your office Aug. 25, 2004.

This section is included “as is” due to time constraints introduced as a result of attempting configure one of our windows xp workstations with “Microsoft windows word” office software. We were forced to install windows 95, 2000 and xp office over the course of one day to accommodate the uspto.gov's electronic filing application named “pasat.” The following day more time was lost discovering the pasat application does not support the current version of the windows operating system xp if all the security patches are applied. Accordingly, we hope this “less than admirable” patent application is met with “flexible empathy and accommodation” given the unexpected time delays associated with an attempt to accommodate pasat.

***This following section descriptions are superseded by previous descriptions when direct conflicts occur. However, should this section include additional insights into the present invention, these added insights should complement previously-specific descriptions. Therefore, if previously section states the “car is red, white and blue with silver wheels” and this section states “the car is black, green and purple with silver and gold-trimmed wheels”, the “gold trim” description should be included as added insights embellishing the previous descriptions.

The present invention provides a web-accessible turnkey activation point for the immediate activation of sophisticated, private, secure and feature-rich community communications networks and support services as a result of “first member” enrollment using a unique community name. Turnkey activation eliminates risks and costs of implementing and operating custom solutions and “freeware” integration. Once activated, other members may join the existing private community using the same online enrollment process. The turnkey enrollment process includes real-time credit card processing, account creation and collection of membership fees. Phone-assisted enrollment processes facilitate large mass community enrollments.

The present invention enables community member to access their relative private community communications network using varying client PCs, varying internet service providers and varying relevant web browsers.

The present invention provides a rich end user experience by providing an adaptable level of detail and functions to accommodate different levels of individual community member interest via the creation of a dynamic hierarchical topical environment in which community members can contribute, interact, view news and information, schedule events, create and respond to surveys, add and view content, and perform other relevant functions at every level of hierarchical topical detail from gross summary high-level down to lowest-level of detail. This creates a rich content path along every click of the dynamic hierarchical drill-down topics/sub-topics menu.

The present invention provides privacy to communities by requiring member ids and passwords logins, and the member's ids, passwords and subsequent community interactions are “clear-text disabled” by securing all transmitted data transmitted from a client PC to host server via https/ssl encrypted client/server connections. Members benefit from the host-server-side ssl server certificate enabling encryption without the loss of access-point PC mobility on their client PC side as when dictated by loading digital certificates for secure email clients. The benefit, the present invention preempts layperson involvement with email digital certificates bringing the members' experiences closer to easy-to-use “toaster-like” appliances that offer secure communications.

The present invention allows the application to be re-branded for marketing purposes.

The present excludes special-purpose client-side PC software requirements to improve community member access-point mobility. A positive side-effect is this decision eliminates imposing community members to periodically participate in technical version control processes to download, install and update special-purpose client-side PC software.

A proprietary scalable hosting infrastructure plan, host operational plans, enrollment plans, and other supporting business process models enabling the delivery of high-quality capabilities at an invisible monthly membership fee.

The objective of this invention is to make-available a web-accessible viable, attractive, low-risk turnkey method for activating high-quality community-oriented communications. This invention provides an alternative to the time, costs, legal risks and potential conflict-of-interests introduced when community leaders and/or community members attempt to manage the design, implementation, testing, deployment, operation, administration, monitoring, support and enhancement of a similar-quality capability.

Using this creation, even non-technical laypersons can effortlessly turnkey activate sophisticated community networks “for community members” that offer superior features over generally-insecure, cumbersome-secure, and functionally-broken email architectures with problems associated with invalid source senders, viruses, access-point limitations, ISP-requirements, etc. In addition, this creation surpasses functional limitations of informational public web sites “about the community”, public linear unorganized message boards, public unorganized forums, inconvenient chat rooms and hard-to-maintain weblogs (aka, “blogs”).

This creation offers superior turnkey features including, but not limited to: id/password access restrictions (private) with ssl-protection on password transmittal from client to server (reliable privacy), ssl-encrypted transactions from client to server (secure), hierarchical-structured content and functions (highly-organized and accommodates the interest level of community member), community-oriented content (pertinent relevancy to day-to-day lifestyle of member), content hosting, backup and recovery, monitoring, customer service and technical support, membership administration, optional content production and maintenance. All membership services are funded via invisible monthly members' fees as an alternative, low-risk method of financing the overall capability.

This turnkey solution includes advanced organizational features and benefits not found in standard “flat/linear” forums, message boards and email systems. This is accomplished via an underlying application hierarchical data-design that governs the placement of both content and functions (a.k.a., “hierarchical process and data positioning architecture”). This underlying data-architecture enables the turnkey solution to be comprised of hierarchical topical data and processes template, upon which all community information, member interactions and supporting functionality is hinged. This framework enables each community to dynamically place information, functions and member interactions at every possible level of a dynamic topical hierarchy. Therefore, this framework enables gross “high-level” content (a.k.a., “parent level segment info”), along with interim increasingly-refined content and function levels, down to the bottom-most level-of-detailed content and functions (a.k.a., “lowest level child segment info”). For example, instead of providing the limited capability of a “community-wide activities calendar”, this system is able to provide both a high-level calendar for “general community events” along with specific calendars for more refined sub-topics such as the “knitting club” or “bowling league.”

Along the way down the hierarchical topical menus, each level of the hierarchy includes supporting functions and dynamic information such as sub-topics, content, messages, calendars, photos, surveys, multimedia presentations, web pages, downloads, and other content as possible. This capability allows dynamic hierarchical community content and dynamic interactions to be applied at all levels of the dynamic topical “drill down” menus.

Enabling one or more community members to immediately create and sometimes alter “personally-owned” community information without causing or relying upon the manual processing of transactions by a third-party administrator. The term “immediately” means member interactions are usually published by host-server-side application within sub-seconds after submittal.

Furthermore, in addition to the ability to create dynamic hierarchical topical menus, the turnkey solution enables hierarchical content and functionality at all levels of the drill-down menus including relevant calendars, relevant member messages, relevant featured stories, relevant surveys, relevant multimedia presentations, relevant web pages, relevant downloads, and other relevant content.

This turnkey solution includes the functional capability of authenticating all message senders prior to transmitting system interactions to other community members or to content areas. Therefore, the common problem of “faking source senders” is eliminated.

This capability is facilitated by a proprietary host-server programming application that affectively leverages a person's basic internet connection into an ability to rapidly establish (i.e., “activate”) access of their private, secure and relevant community information and social interactions.

This invention relates to the creation of an easy-to-use, user-friendly web-accessible capability that enables:
1) Laypersons to turnkey activate; and
2) Mass-produce;

Affordable “private and secure community communications intranets” to support a plurality of separate private communities and their community members each of whom access the resulting activated community via most internet service provider (ISP) internet connections and whom use most web browsing clients.

This patent application seeks to protect this turnkey host-server-based application solution that eliminates costly upfront design, implementation, software integration, test, deployment and operational management costs in exchange for an invisible monthly membership fee.

This functional capability is made available to the general public based upon a host-server-side computer programming application designed to enable most persons (technical and non-technical) with the immediate turnkey capability to activate feature-rich, sophisticated, unique, personalized, id/password private and ssl-encrypted (a.k.a., “secure”) community communications networks (a.k.a. “intranet”) that can be accessed by a plurality of permissioned community members whom mostly use any internet service provider (ISP) internet connection and whom use most any relevant web browsing client.

A turnkey-activated community can be comprised of a plurality of members representing a national, regional, state, city or local community.

By including protection of the underlying data-design (a.k.a., “data architecture”), functional process flows supporting turnkey activation, superior features created by the underlying data-architecture, the methods used by the backend host-server operational administrators to enable scalability of a single-tier host computer, that enable layperson turnkey activation, mass-production, performance and scalability.

Presently, most community-oriented forums, message boards and web sites to not provide laypersons or advanced-knowledge technical persons with the ability of turnkey activation of functionality without a minimal amount of software integration, testing and setup.

Provisional Patent Source Document

For simplicity sake, we have not re-submitted the provisional patent filing paperwork in this corrected package dated Oct. 21, 2004. Phone conversations will USPTO representatives assured us the provisional patent content is inherently considered part of this non-provisional patent review. We may decide to merge any deltas between these two documents through your formalized processes in the future, if needed.

1. A method defining and facilitating a turnkey solution enabling the turnkey activation and mass-production of web-accessible, sophisticated, scalable, extensible, unique, id/password private, ssl secure, community-oriented communications networks;
comprised of:
A detailed technical hardware infrastructure;
A detailed technical software applications infrastructure;
A detailed application functional specification;
A detailed scalable host-server operations plan;
A detailed business functional specification;
A plurality of single-tier host application/ssl web servers connected to the internet;
A plurality of identifiers used for locating said host application/ssl web servers;
A plurality of service members of a community associated with relevant said identifier using internet-connected web browsers;
A method for scaling host servers membership capacity;
A method for securing all member interactions via ssl encryption;
A method where first member enrollment triggers community activation;
A method for enabling dynamic creation of hierarchical topical content and functions;
A method for posting all member interactions immediately;
A method to prevent member session “hijackings” and intrusions;
A method for setting last transaction client PC session-states;
A method for enabling dynamic member-created hierarchical topics, sub-topics, content, interactions, surveys and related functions at every hierarchical topic level;
A method for enabling member's access to their community from varied PC access-points (mobility); comprised of:
a) Enabling access by members who do not own a PC;
b) Enable use of varied relevant internet service providers;
c) Enable use of varied PC clients;
d) Enable use of varied relevant PC operating systems;
f) Enable use of varied relevant web browsing clients;
A method for electronically collecting monthly membership fees;
A method for soliciting encrypted member id and password logins
A method for ensuring all messages sent are from verified members;
A method for preventing message viruses;
A method for preventing unsolicited spam;
A method for preventing anonymous users;
A method for scaling membership capacity to tens-of-millions;
A method for enabling the re-branding of the capability for marketing purposes;
A method for enabling direct-permissioned marketing areas;
A method for measuring system activity;
A method for enabling functional extensibility;
A method for generating community and service-wide alerts;
